(19) United States
(12) Patent Application Publication
(10) Pub. No.: US 2007/0077430 A1
(43) Pub. Date: Apr. 5, 2007

(54) Coated particles and method of making and using

(75) Inventors: Rui Chen, Niskayuna, NY (US); Michael Craig Burrell, Clifton Park, NY (US); Darryl Stephen Williams, Albuquerque, NM (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/239,906

(22) Filed: Sep. 30, 2005

(51) Int. Cl. B32B 1/00

(52) U.S. Cl. 428/403; 106/403; 106/404; 106/401

(57) ABSTRACT

A coated particle, as well as a method of making a coated particle are described. The coated particle includes a core and a coating. The coating at least partially covers the core. The method of making a coated particle includes i) providing a colloidal solution having a core; ii) providing a coating precursor to the colloidal solution to form a resulting solution; and iii) providing an acid, and or adjusting a pH of the resulting solution, and or concentrating.

### BACKGROUND

The invention includes embodiments that relate to coated particles and methods of making and using the same. Particularly, the invention relates to Raman-active coated particles and methods of making and using the same.

1. Description of Related Art

A coating may inhibit particles from aggregating. However, some known methods of coating particles may be time consuming and inefficient. For example, some coating precursor materials may sediment out rather than coat the particle. The more coating material sedimentation, the less material coats the particle.

Thus, methods of coating particles, particularly Raman-active coated particles, that address some of the deficiencies exhibited by known methods are still needed. Also needed are coated particles, particularly Raman-active coated particles that address some of the existing deficiencies.

2. Brief Description

The purpose of embodiments of the invention will be set forth and be apparent from the description of exemplary embodiments that follow, as well as will be learned by practice of the embodiments of the invention. Additional aspects will be realized and attained by the methods and systems particularly pointed out in the written description and claims hereof, as well as from the appended drawings.

An embodiment of the invention provides a coated particle. The coated particle includes a core and a coating. The coating is at least partially disposed on the core and includes a salt derivative.

Another embodiment of the invention provides a coated particle. The coated particle includes a core and a coating. The coating is at least partially disposed on the core and is free of alcohol.

Another embodiment of the invention provides a composition. The composition includes a plurality of cores in a solution. The solution includes an acid and a coating precursor.

Another embodiment of the invention provides a method of making a coated particle. The method includes providing a colloidal solution comprising a core; providing a coating precursor to the colloidal solution to form a resulting solution; and providing acid to the colloidal solution.

Another embodiment of the invention provides a method of making a coated particle. The method includes providing a colloidal solution comprising a core; providing a coating precursor to the colloidal solution to form a resulting solution; and concentrating the colloidal solution.

Another embodiment of the invention provides a method of making a coated particle. The method includes providing a colloidal solution comprising a core; providing a coating precursor to the colloidal solution to form a resulting solution; and adjusting the resulting solution to have a pH less than about 11.

The accompanying figures, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a schematic representation of a coated particle in accordance with an embodiment of the invention;

FIG. 2 is a schematic representation of a Raman-active particle including a Raman-active analyte in accordance with an embodiment of the invention;

FIG. 3 is a schematic representation of a Raman-active particle with a plurality of cores in accordance with an embodiment of the invention;

FIG. 4 is a schematic representation of a method of making a coated particle in accordance with an embodiment of the invention;

FIG. 5 is an overall flow chart of a method of making a coated particle in accordance with an embodiment of the invention;

FIG. 6 is a flow chart of a method of making a coated particle with acid in accordance with an embodiment of the invention;

FIG. 7 is a flow chart of a method of making a coated particle by concentrating in accordance with an embodiment of the invention;

FIG. 8a is a flow chart of a method of making a coated particle by concentrating in accordance with an embodiment of the invention;

FIG. 8b is a flow chart of a method of making a coated particle by concentrating in accordance with an embodiment of the invention;

FIG. 8c is a flow chart of a method of making a coated particle by concentrating in accordance with an embodiment of the invention;

FIG. 8d is a flow chart of a method of making a coated particle by concentrating in accordance with an embodiment of the invention;

FIG. 9 are Transmission Electron Microscopic (TEM) images of coated particles with SiO₂ coating, and cores with an average size of 55 nm in accordance with an embodiment of the invention;

FIG. 10 are TEM images of Raman-active particles with bis(pyridyl)ethylene BPE, SiO₂ coating, and cores with an average size of 53 nm in accordance with an embodiment of the invention;

FIG. 11 are Raman spectra of Raman-active particles with trans-bis (pyridyl)ethylene (BPE) and SiO₂ coating in accordance with an embodiment of the invention;

FIG. 12 is a graph of the Raman signals of Raman-active particles with trans-bis(pyridyl)ethylene (BPE) and SiO₂ coating in accordance with an embodiment of the invention;

FIG. 13 are dynamic light scattering (DLS) spectra of Raman-active particles with BPE and SiO₂ coating in accordance with an embodiment of the invention;

FIG. 14 are also DLS spectra of Raman-active particles with BPE and SiO₂ coating in accordance with an embodiment of the invention;

FIG. 15 are also DLS spectra of Raman-active particles with BPE and SiO₂ coating in accordance with an embodiment of the invention;

FIG. 16 are DLS spectra of Raman-active particles with BPE and SiO₂ coating in accordance with an embodiment of the invention; and

FIG. 17 are Raman spectra of Raman-active particles with BPE and SiO₂ coating in accordance with an embodiment of the invention.

### DETAILED DESCRIPTION OF EXEMPLARY EMBODIMENTS

Reference will now be made in detail to exemplary embodiments of the invention, which are illustrated in the accompanying figures and examples. Referring to the drawings in general, it will be understood that the illustrations are for the purpose of describing a particular embodiment of the invention and are not intended to limit the invention thereto.

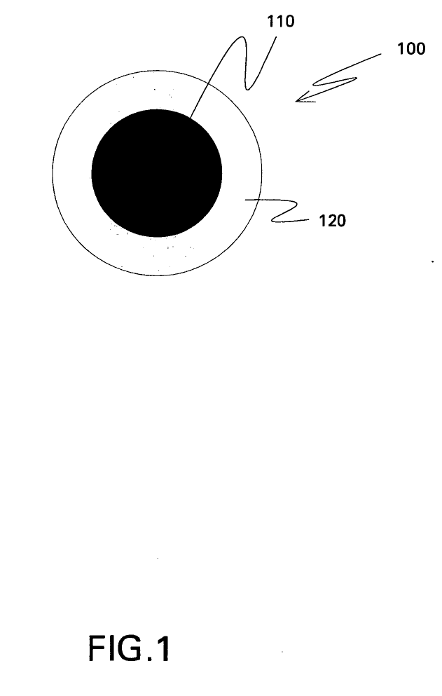

With reference to FIG. 1, there is shown one embodiment of a coated particle 100 that includes a core 110 and a coating 120. The coated particle 110 may include one or more cores 110 and coatings 120.

In one embodiment, the coating includes one or more salt derivatives. Examples of salt derivatives include, but are not limited to, cations and anions, either individually or in any combinations thereof. Particular examples of cations include, but are not limited to, Na⁺, K⁺, Ca²⁺, and Mg²⁺. Particular examples of anions include, but are not limited to, halogens, oxyanions, and organic anions. Non limiting examples of halogens include F⁻, Cl⁻, Br⁻, and I⁻. Non-limiting examples of oxyanions include phosphate, carbonate, sulfate, sulfite, nitrate, and nitrite. Non-limiting examples of organic anions include acetate, formate, benzoate, and citrate.

Examples of salt derivatives also include a byproduct of a reaction between an acid that is added and a coating precursor. Examples of acids include, but are not limited to hydrofluoric acid, hydrochloric acid, hydrobromic acid, hydroiodic acid, phosphoric acid, carbonic acid, sulfuric acid, sulfurous acid, nitric acid, nitrous acid, acetic acid, formic acid, benzoic acid and derivatives, and citric acid, either individually or in any combinations thereof. In a particular embodiment, the salt derivative includes Cl. The Cl may be a byproduct of a reaction between HCl acid that is added and a coating precursor.

The coating may includes salt derivative in different ranges, such as less than about 10% by weight of the coating, less than about 5% by weight of the coating, or less than about 1% by weight of the coating. In a particular embodiment, the coating includes a trace amount of salt derivative ranges, such as less than 0.01% by weight of the coating. Approximating language, as used herein throughout the specification and claims, may be applied to modify any quantitative or qualitative representation that could permissibly vary without resulting in a change in the basic function to which it is related. Accordingly, a value modified by a term such as “about” is not to be limited to the precise value specified, and may include values that differ from the specified value. In at least some instances, the approximating language may correspond to the precision of an instrument for measuring the value. “A trace or insignificant amount” may be used in combination with a term, and may include an insubstantial number or trace amount of salt derivatives while still being considered present.

In another embodiment, the coating is free of alcohol. Free may be used in combination with a term, and may include an insubstantial number or trace amount of alcohol while still being considered free. “Free” includes substantially free, such as an alcohol content of less than about 10%, less than 1%, or less than 0.01% by weight. Examples of alcohol include methanol, ethanol, propanol, butanol, and tert-butanol. In a particular embodiment, the coating is free of ethanol, and more particularly has an ethanol content of less than about 1% or less than 0.01% by weight.

The coated particles may be of various material, shape and size as described below. In one embodiment, the core has a metallic surface. The core may include a metal such as, but not limited to, Au, Ag, Cu, Ni, Pd, Pt, Na, Al, and Cr, either individually or through any combination thereof. The core may include any other inorganic or organic material provided the surface of the core is metallic. In a particular embodiment, the core includes Au.

The shape of the core may vary based on the desired application. For example, the core may be in the shape of a sphere, fiber, plate, cube, tripod, pyramid, rod, tetrapod, or any non-spherical object. In one embodiment, the core is substantially spherical.

The size of the core also may vary and can depend on its composition and intended use. In one embodiment, the cores have an average diameter in a range from about 1 nm to less than about 500 nm. In another embodiment, the cores have an average diameter less than about 100 nm. In yet another embodiment, the cores have an average diameter in a range from about 12 nm to less than about 100 nm.

In one embodiment, the coating includes a material which stabilizes the coated particle or core against aggregation. The coating stabilizes the particle in one way by inhibiting aggregation of cores. The coating is sufficiently thick to stabilize the particle. In one embodiment, the coating has a thickness in a range from about 1 nm to less than about 500 nm. In another embodiment, the coating has a thickness less than about 50 nm. In yet another embodiment, the coating has a thickness in a range from about 5 nm to less than about 30 nm.

In one embodiment, the coating includes an elemental oxide. In a particular embodiment, the element in the elemental oxide includes silicon. The percentage of silicon may depend on one or more factors. Such factors may include the intended use of the coated particle, the composition of the core, the degree to which the coating is to be functionalized, the desired density of the coating for a given application, the desired melting point for the coating, the identity of any other materials which constitute the coating, and the technique by which the Raman-active particle is to be prepared. In one embodiment, the element in the elemental oxide of the coating includes at least about 50-mole % silicon. In another embodiment, the element in the elemental oxide of the coating includes at least about 70-mole %. Yet, in another embodiment, the element in the elemental oxide of the coating includes substantially silicon.

In yet another embodiment, the coating includes a composite. The composite coating may include oxides of one or more elements such as, but not limited to, Si, B, Al, Ga, In, Sc, Y, La, Ti, Zr, Hf, V, Nb, Ta, Cr, Mn, Fe, Co, Ni, Li, Na, K, Rb, Cs, Be, Mg, Ca, Sr, Ba, Zn, Cd, Ge, Sn, and Pb. Furthermore, the coating may include multilayer coatings. Each of the coating layers in the multilayer coating individually may include different coating compositions, such as 50-mole % silicon oxide in one coating layer and a composite coating in another coating layer.

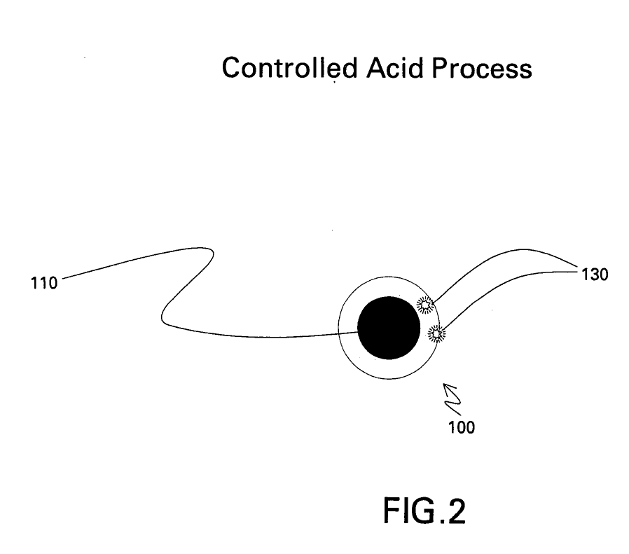

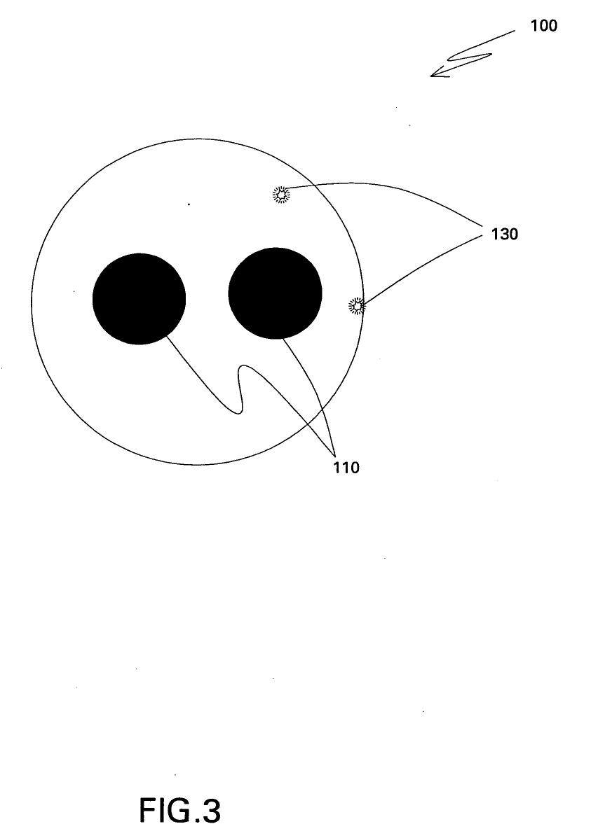

In a particular embodiment, the coated particle is Raman active and includes one or more Raman-active analytes 130, as shown in FIG. 2 and FIG. 3. Unless noted otherwise, Raman and Raman-active includes Raman, surface enhanced Raman spectroscopy, and Resonance Raman. It should be appreciated that one or more cores, coatings, and analytes may be included within the Raman-active particle. In a particular embodiment, the Raman-active analyte is at least partially within the coating and the coating at least partially covers the core. In a more particular embodiment, the coating substantially covers the core.

In one embodiment, the Raman-active analyte includes a molecule that exhibits Raman scattering when in the vicinity of a metallic core or the metallic surface of a core. Examples of Raman-active analytes include, but are not limited to, 4-mercaptopyridine, 2-mercaptopyridine(MP), trans-bis(pyridyl)ethylene (BPE), naphthalene thiol (NT), 4,4′-dipyridyl (DPY), quinoline thiol (QSH), and mercaptobenzoic acid, either individually or any combination thereof. In a particular embodiment, the Raman-active analyte includes BPE.

In one embodiment, the Raman-active analyte is at least partially within the coating. The Raman-active analyte can be at least partially within the coating in various orientations, such as, but not limited to, dispersed within the coating, within and around the coating, or embedded within the coating. Furthermore, a plurality of analytes may be within the coating. The plurality of analytes may be within the coating at a plurality of sites or at a single site. Each of the analytes may be within the coating by a different mode, such as dispersed within the coating, around the coating, or embedded within the coating.

The Raman-active particle may include a single core within a coating as in FIG. 2 or multiple cores within a coating, as in FIG. 3. The multiple cores are non-aggregated or closer together. There may be particular advantages associated with Raman-active particles that have one core within a coating or multiple cores within a coating. The selection as to how many cores should be contained within a coating may depend on the particular application for which the Raman-active particles are being used. Adjusting process conditions may be effective in obtaining Raman-active particles with a single core contained in the coating. For example, the coating may also stabilize a core against aggregating with another core.

The Raman-active particle may vary in shape and size. In one embodiment, the Raman-active particles are substantially spherical and have an average diameter less than about 1000 nm. In a particular embodiment, the Raman-active particles have an average diameter less than about 100 nm.

In one embodiment, the Raman-active particle includes one or more linkers. The linker binds to the core and interacts with the coating. The linker allows or facilitates the coating to attach to the core. The linker may be a molecule having a functional group. The functional group can bind to the metal surface of the core and bind to the coating. An example of a linker is alkoxysilanes. Examples of alkoxysilanes include trialkoxysilanes. Trialkoxysilane linkers may be used to deposit coatings comprising silica. Suitable trialkoxysilane linkers include, but are not limited to, aminopropyl trimethoxysilane (APS), aminopropyl triethoxysilane, mercaptopropyl trimethoxysilane, mercaptopropyl triethoxysilane, hydroxypropyl trimethoxysilane, and hydroxypropyl triethoxysilane, either individually or in any combinations thereof.

When more than one analyte, coating, linker, and core are present, the definition on each occurrence is independent of the definition at every other occurrence. Also, combinations of an analyte, coating, linker, and core are permissible if such combinations result in stable Raman-active particles. Also, methods in combining an analyte, coating, linker, and core are permissible if such combinations result in stable Raman-active particles.

Another embodiment of the invention provides a composition. The composition includes cores in a solution. The solution includes an acid and a coating precursor. In one embodiment, the cores are suspended in a solution.

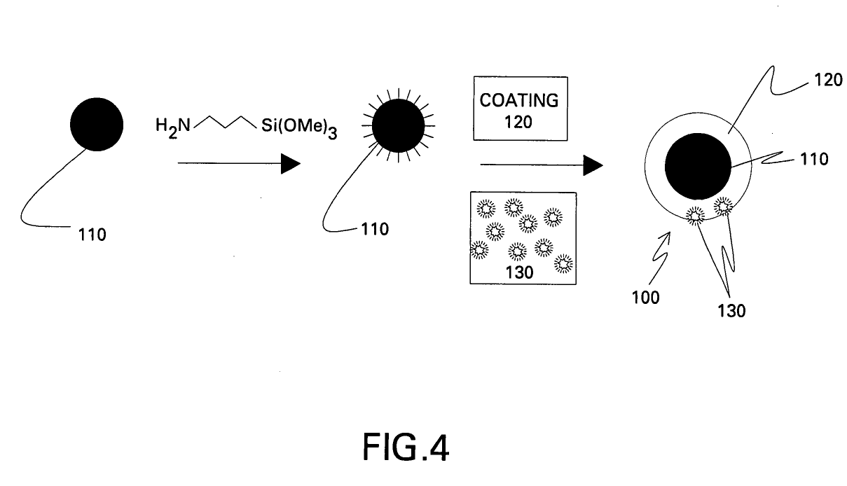

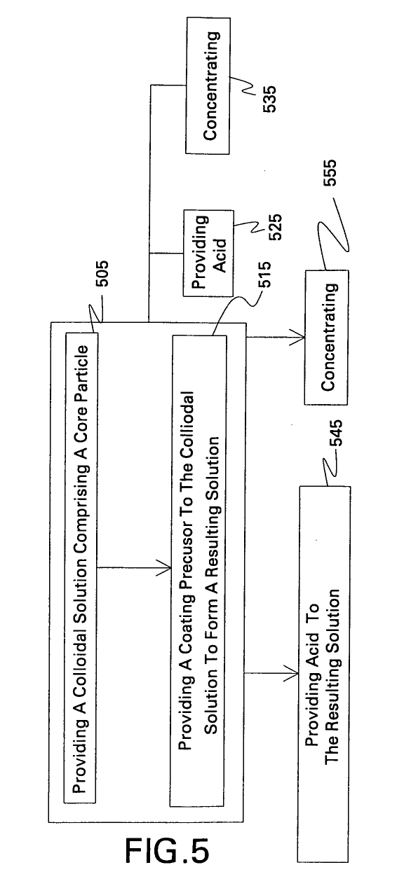

With reference to FIGS. 4-8A-D, methods of making a coated particle are described. FIG. 4 is a schematic representation of a method of making coated particle. FIG. 5-8A-D are flow charts of methods of making a coated particle. In FIG. 5, the method includes a Step 505 of providing a colloidal solution comprising a core. The core may be an Au particle. The core that is provided may already be at least partially coated. The average size of the Au particles and amount of the colloidal solution may vary, such as for example, 50 mL of a 50 nm Au particles. The Au particle may be treated with ion exchange resin and filtered prior to beginning the coating reaction.

At step 515, a coating precursor is provided to the colloidal solution to form a resulting solution. The coating precursor is any material capable of at least partially coating the core. The coating precursor may be provided in the form of a sodium silicate solution or any other source of silica.

As shown in FIG. 5, the method may also include providing an acid (Step 525 or 545) or concentrating (Step 535 or 555), or both. Furthermore, the method is not limited by when providing the acid (Step 525 or 545) and or concentrating (Step 535 or 555) occurs in relation to each other or other steps. The method is also not limited by how often providing the acid (Step 525 or 545) and or concentrating (Step 535 or 555) occurs.

Acid or Adjusting pH

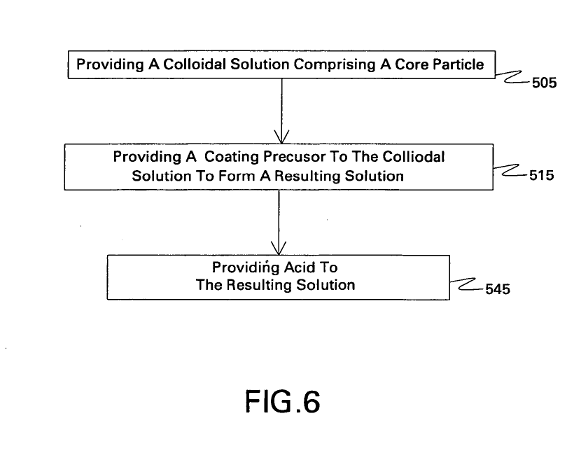

In one embodiment, as shown in FIG. 5 and FIG. 6, the method includes providing an acid. The method is not limited by when the colloidal solution, coating precursor, and acid are provided relative to each other. In one embodiment, the colloidal solution, coating precursor, and acid may be simultaneously provided. In another embodiment, the colloidal solution is provided prior to the coating precursor. In yet another embodiment, the acid is provided after the coating precursor, as shown in FIG. 6 (Step 545). The acid may also be provided with the coating precursor and the acid may also be repeatedly provided at different times, as shown in FIG. 5 (Step 525, 545).

Examples of acids include, but are not limited to, hydrofluoric acid, hydrochloric acid, hydrobromic acid, hydroiodic acid, phosphoric acid, carbonic acid, sulfuric acid, sulfurous acid, nitric acid, nitrous acid, acetic acid, formic acid, benzoic acid, and citric acid, either individually or in any combinations thereof. In one embodiment, the acid includes HCl. The acid may be provided in a slow gradual manner over a period of gradual pH change. The acid may be provided dropwise to adjust the pH to less than about 11. In a particular embodiment, the pH is less than about 10. In a more particular embodiment, the pH is in a range from about 8 to about 9.

Acid addition may have one or more effects. Such effects may include shorten reaction time, decreased reagent cost, reduced washing cycles to remove ethanol relative to classic Stober growth. Furthermore, adding acid may improve the reproducibility of Raman signals among different preparation batches.

Another embodiment also includes adjusting the pH by ion-exchange, electrolysis, photolysis, or enzymes, either individually or in any combinations thereof. Examples of enzymes include, but are not limited to, glucose oxidase, penicillinase, urease, pipase, isocitrate dehydrogenase, and malate dehydrogenase. In a particular embodiment, the resulting solution is adjusted to have a pH less than about 11. In a particular embodiment, the pH is less than about 10. In a more particular embodiment, the pH is in a range from about 8 to about 9.

Concentrating

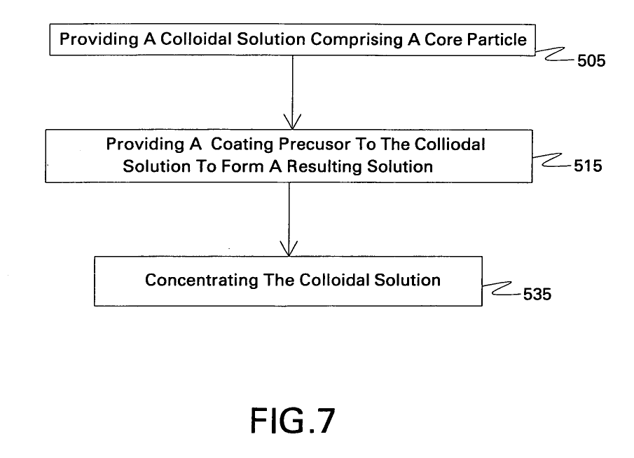

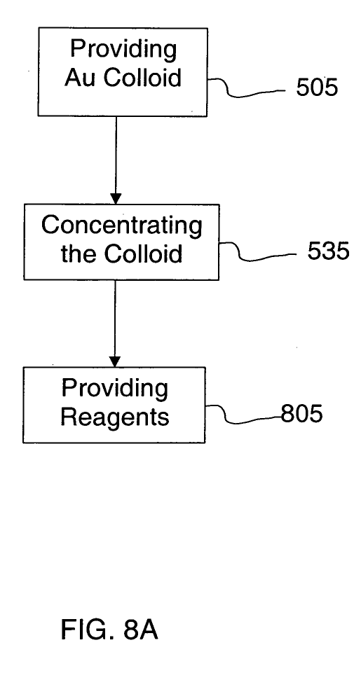

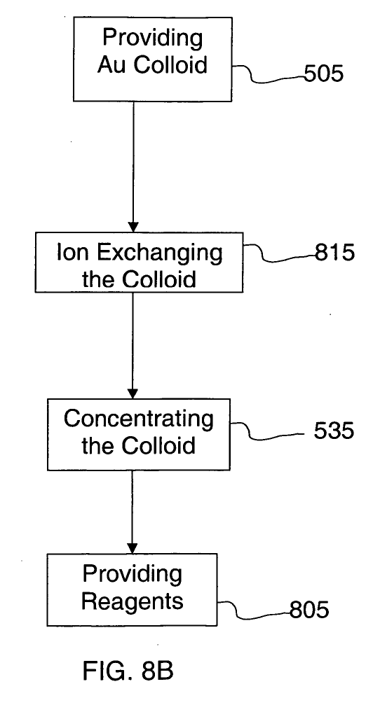

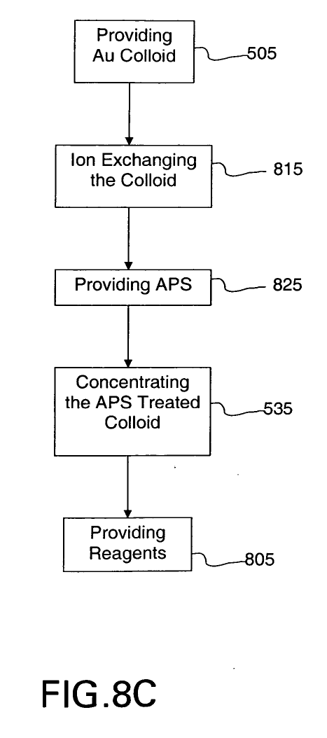

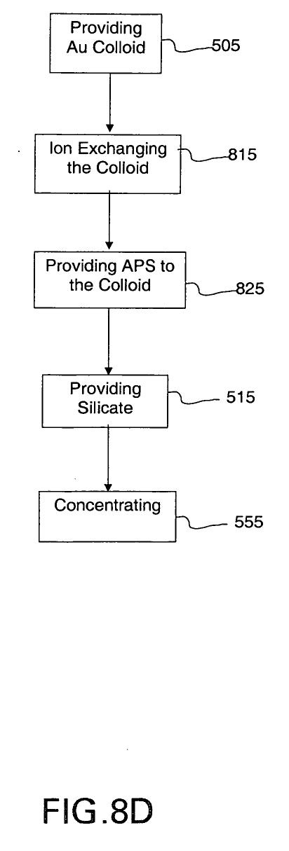

In one embodiment, as shown in FIG.7 and 8A-8D, the method includes concentrating the colloidal solution, such as by centrifuging (Step 535, 555). The method is not limited by how, when, and how frequently concentrating occurs. Modes of concentrating the colloidal solution include, but are not limited to, centrifugation, sedimentation, filtration, and chromatography, either individually or in any combinations thereof. In a particular embodiment, concentrating includes centrifuging. In one embodiment, concentrating includes decreasing the solvent or liquid component by at least fold.

FIG. 7 and 8A-8D show that the method is also not limited by when or how often concentrating occurs. In a particular embodiment, concentrating the colloidal solution (Step 535) occurs prior to providing the coating precursor such as silica (Step 515), as shown in FIG. 8A as well as FIG. 8B-8C. In another embodiment, concentrating the colloidal solution (Step 555) occurs after providing the coating precursor (Step 515), as shown in FIG. 8D. In yet another embodiment, the method further includes concentrating the coating precursor. The method further includes performing other steps such as ion exchanging (Step 815) or providing reagents (Step 805) as shown in FIG. 8A-D. Reagent is used generally herein to include the addition of any material. Examples of reagents include linkers such as aminopropyl trimethoxysilane (APS), Raman active analytes, and coating materials. FIG. 8A-8D also show that the method is also not limited by when or how often concentrating occurs in relation to other steps, such as providing reagent or ion exchanging.

In one embodiment, Raman-active analyte is provided to the resulting solution. Examples of Raman-active analytes include, but are not limited to, 4-mercaptopyridine, 2-mercaptopyridine, trans-bis(pyridyl)ethylene, naphthalene thiol, mercaptobenzoic acid, either individually or in any combinations thereof. In a particular embodiment, at least a partial coating of the core is initiated before providing the Raman-active analyte. However, the coating does not have to be completed before providing the Raman-active analyte. The providing of a coating precursor and providing of the Raman-active analyte may occur simultaneously or overlap as the Raman-active analyte may be provided concurrently with the completion of the coating, but after the coating is initiated.

Alkoxysilane linkers such as aminopropyl trimethoxysilane (APS) or mercaptopropyl trimethoxysilane (EMS) may be added to facilitate the deposition onto the core. The amino group of the aminopropyl trimethoxysilane binds to the surface of the core. The alkoxysilane hydrolyzes to form siloxy or hydroxy silyl groups. The hydrolyzed silane condenses with silicate in the silicate solution provided. In this way, the core acts as a seed for growth of a, silica coating. In one embodiment, a layer of silica coating is deposited by adding a basic sodium silicate solution to an APS-modified colloidal gold core. The high surface area of the APS-modified colloidal gold core provides nucleation sites onto which the silicate coating may deposit. This coating reaction using basic sodium silicate is referred to as the Water-glass reaction.

In still another embodiment, the method further includes heating the resulting solution. In a particular embodiment, heating the resulting solution includes heating the resulting solution to a temperature in a range from about 50° C. to about 70° C.

### EXAMPLES

The following examples illustrate the features of the invention and are not intended to limit the invention thereto.

The examples include synthesizing coated particles with varying average sizes of cores, with or without adding acid, with or without concentrating, and with or without Raman active analytes as summarized in Table I.

TABLE I
Synthesis of coated particles

| EXAMPLE | ACID | CONCENTRATING | ANALYTE |
|---|---|---|---|
| 1 | Yes | Yes | No |
| 2 | Yes | Yes | Yes |
| 3A | No | Yes | Yes |
| 3B | No | Yes | Yes |
| 3C | No | Yes | Yes |
| 3D | No | Yes | Yes |

### Example 1 and Example 2

Example 1 and Example 2 respectively demonstrate synthesizing coated gold nanoparticles with acid addition and concentration, and respectively without and with Raman active analytes, as shown in Table II below.

TABLE II
acid addition and concentration

| | | | Size of Au | Raman-active |
|---|---|---|---|---|
| Example | ACID | CONCENTRATING | cores (nm) | Analyte |
| 1 | Yes | Yes | 55 | No |
| 2 | Yes | Yes | 53 | Yes |

### Example 1

### Synthesizing Coated Gold Nanoparticles with Acid Addition and Concentration, without Raman Active Analytes

Aqueous colloidal gold (100 mL) (0.005% Au w/w, 55-nm average diameter) was concentrated by centrifuging and re-suspended in a total volume of 15 mL. The colloid was placed in a 50 mL plastic centrifuge tube and the following reagents were added sequentially with stirring: 80 μL of 10 mM aminopropyltri-methoxysilane in water and 100 μL 5.4% sodium silicate solution. The reaction mixture was transferred to a 50-mL, 3-necked glass round bottom flask and maintained at 60° C. An addition funnel dispensed a total of 13 mL of 10 mM HCl into the mixture, at a rate of 3 mL/hour. The reaction product was cooled, purified by repeated centrifugation, and re-suspended in 10 mL of deionized water.

The thickness and uniformity of the silica coating on the colloidal gold particles was measured and confirmed using visible absorption spectroscopy, dynamic light scattering, and transmission electron microscopy. About 15 nm-thick well-defined glass coating was observed.

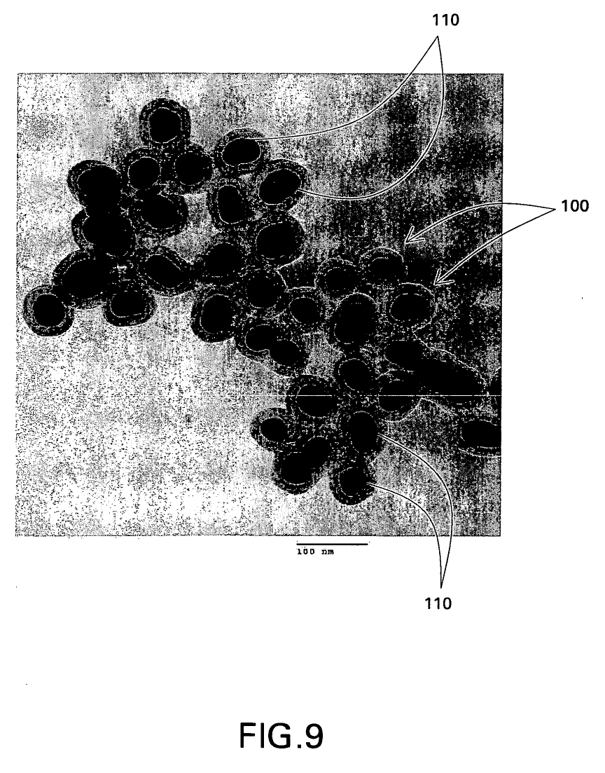

FIG. 9 are TEM images of the embodiments of the coated particles in Example 1. The TEM images demonstrate that the coated particles are non-aggregated and nanoscale sized (55 nm). The coated particles also have a monomodal distribution of that observed in the preparation of gold colloids. Unless otherwise noted, substantially non-aggregated nanoparticle includes nanoparticles having an average diameter less than 100 nm. Unless otherwise noted, substantially monodisperse coated particle means a standard deviation of up to about 20%, particularly up to about 10%.

### Example 2

### Synthesizing Coated gold Nanoparticles with Acid Addition and Concentration, with Raman Active Analytes

Aqueous colloidal gold (200 mL) (0.005% Au w/w, 53-nm average diameter) was concentrated by centrifuging and re-suspended in a total volume of 35 mL. The colloid was placed in a 150 mL plastic beaker and the following reagents were added sequentially with stirring: 160 μL of 10 mM aminopropyltrimethoxy-silane in ethanol; 800 μL 5.4% sodium silicate solution; and a mixture of 800 μL water plus 80 μL of an ethanol solution 10 mM 1,2-bis(4-pyridylethylene). The reaction mixture was transferred to a 150-mL, 3-necked glass round bottom flask and maintained at 60° C. An addition funnel was used to dispense 20 mL of 20 mM HCl into the mixture, at a rate of 2-3 mL/hour. The reaction product was cooled, purified by repeated centrifugation, and finally re-suspended in 35 mL of deionized water.

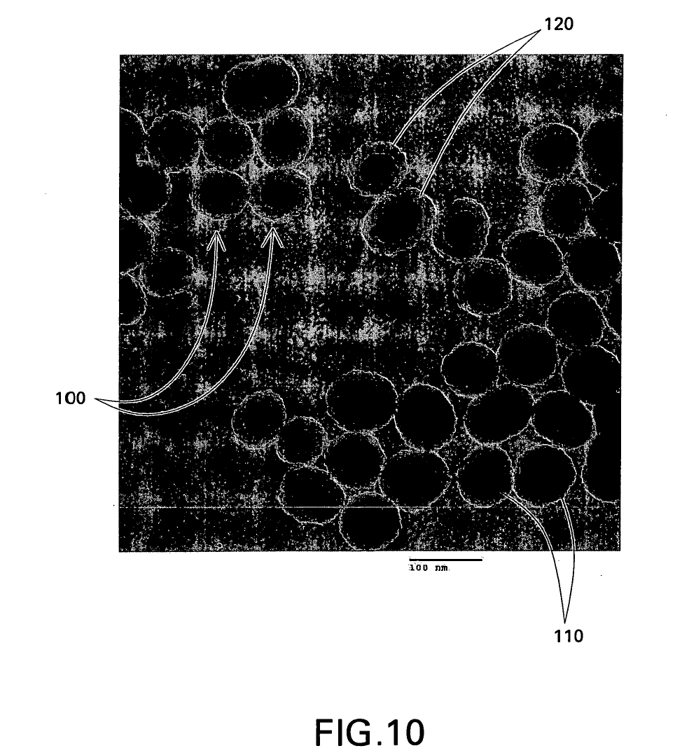

FIG. 10 are TEM images of the embodiments of Raman-active coated particles in Example 2. The TEM images demonstrate that the Raman-active coated particles are non-aggregated and nanoscale sized (53 nm). The Raman-active coated particles also have a monomodal distribution.

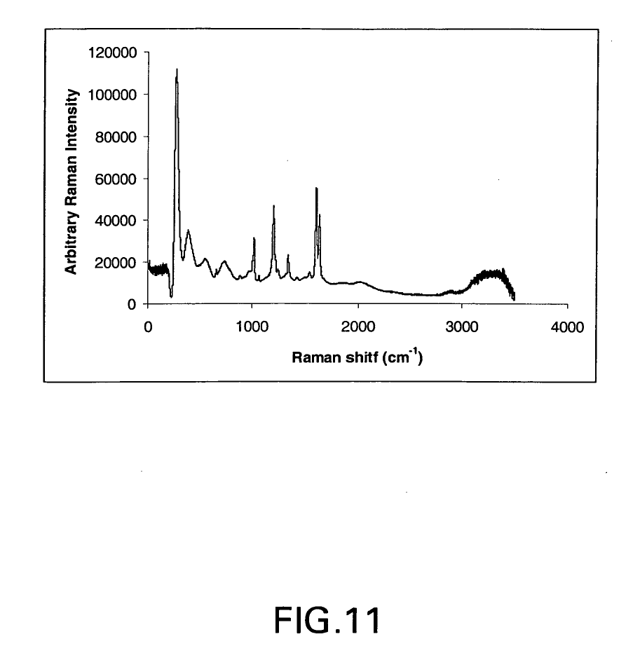

FIG. 11 are Raman spectra of Raman-active coated particles in Example 2 with trans-bis(pyridyl)ethylene (BPE) and SiO₂ demonstrating the activeness of the Raman-active coated particles.

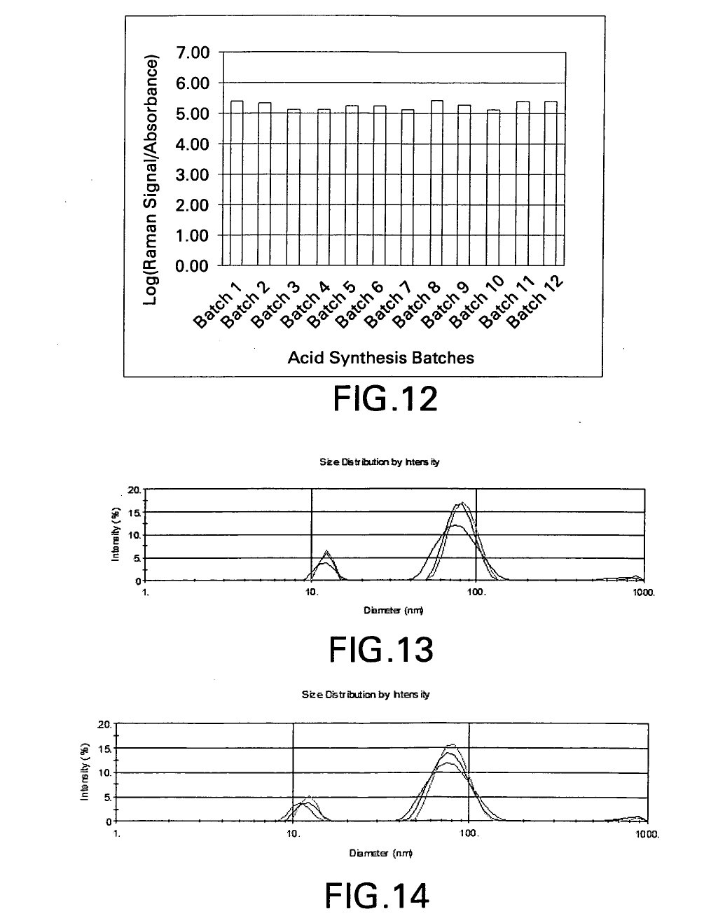

FIG. 12 is a graph of the Raman signals of several batches of Raman-active particles with trans-bis(pyridyl)ethylene (BPE) and SiO2 . The graph demonstrates that adding acid improves the reproducibility of Raman signals among different preparation batches.

### Examples 3A-3D

Examples for concentrating at different times in relation to adding of other reagents.

TABLE III
concentrating at different times

| | Size of | | | |
|---|---|---|---|---|
| | Au cores | Concentration | | Reagent addition |
| Example | (nm) | step | Analyte | sequence |
| 3A | 50 | Prior to | Yes | Add linker and |
| | | reagent | | silicate together, |
| | | addition | | wait 15 min, |
| | | | | then add Raman- |
| | | | | active analyte |
| 3B | 50 | Prior to | Yes | Add linker, silicate, |
| | | reagent | | and Raman-active |
| | | addition | | analyte sequentially, |
| | | | | 15 min interval |
| 3C | 50 | Prior to | Yes | Add linker, silicate |
| | | reagent | | and Raman-active |
| | | addition | | analyte all together |
| 3D | 60 | After adding | Yes | Add linker, silicate, |
| | | linking agent | | and Raman-active |
| | | and silicate | | analyte sequentially, |
| | | | | 15 min interval |

### Example 3A

### Au core (50 nm) with BPE and SiO₂

Aqueous colloidal gold (50 mL) (0.005% Au w/w, 50-nm average diameter) was concentrated by centrifuging and re-suspended in a total volume of 8.5 mL. 40 μL APS (10 mM) and 400 μL 5.4% sodium silicate solution were then added dropwise with stir. After 15 min, 40 μL of 10 mM BPE solution in ethanol was diluted in 360 μL water and this diluted BPE solution was added dropwise. Water was added to this reaction mixture to make a final volume of 10 mL. Then the reaction mixture was left on the shelf for 30 days. The reaction product was purified by repeated centrifugation.

FIG. 13 are DLS images of the embodiments of Raman-active coated particles in Example 3A. The DLS images demonstrate that the Raman-active coated particles are substantially non-aggregated and nanoscale sized (average diameter of 81 nm). The Raman-active coated particles also have a monomodal distribution.

The DLS intensity plots show the distribution of scattered light intensity proportional to size. The three different plots represent results from three measurement runs. Intensity plots for a typical monomodal colloidal gold solution will exhibit a large peak representing the average size distribution of the colloid, and a much smaller peak in the 5-15 nm range. The peaks on the DLS data roughly correspond to this relative size distribution. The smaller peak appears to be due to the small percentage of coated particles having non-spherical geometries (pyramidal)

### Example 3B

### Au core (50 nm) with BPE and SiO₂

Aqueous colloidal gold (50 mL) (0.005% Au w/w, 50-nm average diameter) was concentrated by centrifuging and re-suspended in a total volume of 8.5 mL. 40 μL APS (10 mM) was added dropwise with stirring. After 15 min, 400 μL 5.4% sodium silicate solution was added dropwise. After another 15 min, 40 μL of 10 mM BPE solution in ethanol was diluted in 360 μL water and this diluted BPE solution was added dropwise. Water was added to this reaction mixture to make a final volume of 10 mL. The reaction mixture was left to sit on the shelf for 30 days. The reaction product was purified by repeated centrifugation.

FIG. 14 are DLS images of the embodiments of Raman-active coated particles in Example 3B. The DLS images demonstrate that the Raman-active coated particles are substantially non-aggregated and nanoscale sized (average diameter of 79 nm). The Raman-active coated particles also have a monomodal distribution similar to that observed in the preparation of gold colloids.

### Example 3C

### Au core (50 nm) with BPE and SiO₂

Aqueous colloidal gold (50 mL) (0.005% Au w/w, 50-nm average diameter) was concentrated by centrifuging and re-suspended in a total volume of 8.5 mL. 40 μL of 10 mM BPE solution in ethanol was diluted in 360 μL water and this diluted BPE solution was added together with 40 μL APS (10 mM) and 400 μL 5.4% sodium silicate solution dropwise with stir. Water was added to this reaction mixture to make final volume of 10 mL. Then the reaction mixture was left on the shelf for 30 days. The reaction product was purified by repeated centrifugation.

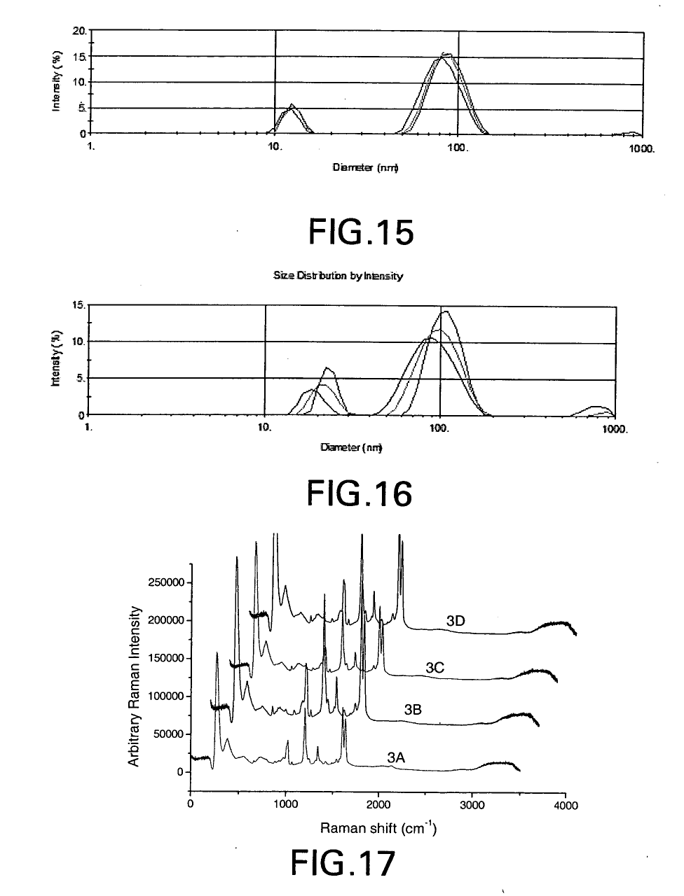

FIG. 15 are DLS images of the embodiments of Raman-active coated particles in Example 3C. The DLS images demonstrate that the Raman-active coated particles are substantially non-aggregated and nanoscale sized (average diameter of 86 nm). The Raman-active coated particles also have a monomodal distribution similar to that observed in the preparation of gold colloids

### Example 3D

### Au core (50 nm) with BPE and SiO₂

Ion exchange resin (1 g) was treated for 30 min and filtered through a 200 nm cellulose nitrate filter 100 mL of aqueous colloidal gold (0.005% Au w/w, 60-nm average diameter). The solution was placed in a plastic beaker. APS (80 μL) (10 mM) was added dropwise followed by stirring for 30 min. 8 g of 0.54% sodium silicate solution was then added dropwise followed by stirring for 30 min. The solution was concentrated by centrifugation, and re-suspended in a total volume of 10 mL. 5 mL of this concentrated colloid was treated with 40 μL APS (10 mM) and 400 μL 5.4% sodium silicate, added dropwise with stirring. 60 μL of 10 mM BPE solution in ethanol was diluted in 600 μL water and this diluted BPE solution was added dropwise followed by stirring for 72 hours. After 20 days, the solution was purified by repeated centrifugation.

FIG. 16 are DLS images of the embodiments of Raman-active coated particles in Example 3B. The DLS images demonstrate that the Raman-active coated particles are substantially non-aggregated and nanoscale sized (average diameter of 100 nm). The Raman-active coated particles also have a monomodal distribution typical of that observed in the preparation of gold colloids.

FIG. 17 are Raman spectra of the embodiments of the Raman-active coated particles in Examples 3A-CD with BPE analyte and SiO₂ coating demonstrating the activeness of the Raman-active coated particles.

Concentrating improved the thickness and uniformity of the coating. The thickness and uniformity of the silica coating on the colloidal gold particles was measured and confirmed using visible absorption spectroscopy, dynamic light scattering, and transmission electron microscopy. About 15 nm-thick well-defined glass coating was observed.

While the invention has been described in detail in connection with only a limited number of aspects, it should be readily understood that the invention is not limited to such disclosed aspects. Rather, the invention can be modified to incorporate any number of variations, alterations, substitutions or equivalent arrangements not heretofore described, but which are commensurate with the scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A coated particle comprising:
a core;
a coating at least partially disposed on the core; and
wherein the coating comprises a salt derivative.

2. The coated particle of claim 1, wherein the core comprises at least one metal selected from a group consisting of Au, Ag, Cu, Ni, Pd, Pt, Na, Al, Cr, and combinations thereof.

3. The coated particle of claim 2, wherein the core comprises a metallic surface.

4. The coated particle of claim 1, wherein the coated particle is Raman-active.

5. The coated particle of claim 1, wherein the coated particle has a diameter less than about 1000 nm.

6. The coated particle of claim 1, wherein the core has a diameter less than about 100 nm.

7. The coated particle of claim 1, wherein the coated particle is free of alcohol.

8. The coated particle of claim 1, wherein the salt derivative comprises a member selected from a group consisting of cations and anions.

9. The coated particle of claim 8, wherein the cations and anions are selected from a group consisting of Na⁺, K⁺, Ca²⁺, aMg²⁺, F⁻, Cl⁻, Br⁻, and I⁻, phosphate, carbonate, sulfate, sulfite, nitrate, nitrite, acetate, formate, benzoate, and citrate.

10. The coated particle of claim 8, wherein the salt derivative comprises a byproduct of a reaction between an acid and a coating precursor.

11. A coated particle comprising:
a core;
a coating at least partially disposed on the core; and
wherein the coating is free of alcohol.

12. The coated particle of claim 11, wherein the coating further comprises a salt derivative.

13. The coated particle of claim 12, wherein the salt derivative comprises a member selected from a group consisting of cations and anions.

14. The coated particle of claim 13, wherein the cations and anions are selected from a group consisting of Na⁺, K⁺, Ca²⁺, aMg2+, F⁻, Cl⁻, Br⁻, and I⁻, phosphate, carbonate, sulfate, sulfite, nitrate, nitrite, acetate, formate, benzoate, and citrate.

15. The coated particle of claim 12, wherein the salt derivative comprises a byproduct of a reaction between an acid and a coating precursor.

16. The coated particle of claim 11, wherein the coated particle is Raman active.

17. The coated particle of claim 11, wherein the core comprises at least one metal selected from a group consisting of Au, Ag, Cu, Ni, Pd, Pt, Na, Al, Cr, and combinations thereof.

18. The coated particle of claim 17, wherein the core comprises a metallic surface.

19. The coated particle of claim 11, where the alcohol is ethanol.

20. The coated particle of claim 11, where free of alcohol comprises an alcohol content of less than about 1%.

21. The coated particle of claim 11, wherein the coated particle has a diameter less than about 1000 nm.

22. The coated particle of claim 11, wherein the core has a diameter less than about 100 nm.

23. A composition comprising:
a plurality of cores in a solution; and
wherein the solution comprises an acid and a coating precursor.

24. The composition of claim 23, wherein the acid comprises at least an acid selected from a group consisting of hydrofluoric acid, hydrochloric acid, hydrobromic acid, hydroiodic acid, phosphoric acid, carbonic acid, sulfuric acid, sulfurous acid, nitric acid, nitrous acid, acetic acid, formic acid, benzoic acid, and citric acid.
